(19) United States
(12) Patent Application Publication
(10) Pub. No.: US 2025/0229806 A1
(43) Pub. Date: Jul. 17, 2025

(54) AUTONOMOUS MANEUVERING OF VEHICLE INTO SERVICE STATION

(71) Applicant: Valeo Schalter und Sensoren GmbH, Bietigheim-Bissingen (DE)

(72) Inventors: Ahmad YAME, Bietigheim-Bissingen (DE); Besnik JASHARI, Bietigheim-Bissingen (DE); Faisal Mohammed AKBAR, Bietigheim-Bissingen (DE); Fayed Mohammed AKBAR, Bietigheim-Bissingen (DE)

(21) Appl. No.: 18/411,163

(22) Filed: Jan. 12, 2024

(51) Int. Cl. B60W 60/00; B60W 50/14

(52) U.S. Cl. CPC B60W 60/0025; B60W 50/14; B60W 60/0051; B60W 2050/146; B60W 2420/403; B60W 2554/60; B60W 2556/40

(57) ABSTRACT

Methods and systems for autonomously maneuvering a vehicle into a service station. Images are received from one or more vehicle cameras, and processed by a computer vision (CV) machine-learning model. The CV model is configured to determine a presence of at least one rail near the vehicle. The location of the vehicle is determined to be near a service station based upon the determined presence of the at least one rail. A user interface displays an interactive display providing an operator of the vehicle with an option to command the vehicle to activate a low-speed maneuvering system. This is generated in response to the determination of the vehicle location being near the service station. The vehicle autonomously maneuvers into the service in response to the low-speed maneuvering system being activated. The autonomous maneuvering is performed based on the determined location of the at least one rail.

### TECHNICAL FIELD

The present disclosure relates to autonomously maneuvering a vehicle into a service station, such as a car wash or oil change facility.

### BACKGROUND

Computer vision systems are integral components of many modern automotive vehicles, primarily used to enhance safety and enable autonomous functions. These systems rely on cameras and sensors to collect real-time data from the vehicle's environment. Through the application of advanced machine learning algorithms, this data is analyzed to identify and classify objects like pedestrians, vehicles, and road signs. The insights generated by computer vision systems empower functionalities such as adaptive cruise control and lane-keeping assistance, contributing to improved safety and efficiency in vehicles.

Autonomous vehicles have revolutionized the way people envision transportation, offering potential benefits like improved safety, reduced traffic congestion, and increased efficiency. However, there are challenges when it comes to their interaction with service stations and car washes. Autonomous vehicles rely heavily on precise mapping and sensor technology for navigation, which can be problematic in these scenarios. For one, service stations and car washes often require very precise wheel placement so that a vehicle repair person can access the underside of the vehicle, or so that the vehicle is properly aligned with the tracks that move the vehicle through a car wash. Additionally, service stations and car washes often lack the standardized and updated mapping data required for autonomous vehicles to navigate accurately.

### SUMMARY

According to one embodiment, a method for autonomously maneuvering a vehicle into a service station. The method includes: receiving images from one or more cameras mounted to the vehicle; processing the images via a computer vision (CV) machine-learning model, wherein the CV machine-learning model is configured to determine a presence of at least one rail located in front of the vehicle; determining that the vehicle is located near a service station based upon at least the determined presence of the at least one rail; generating, on a vehicle user interface, an interactive display providing an operator of the vehicle with an option to command the vehicle to activate a low-speed maneuvering system, wherein the interactive display is generated in response to the determination that the vehicle is located near the service station; and maneuvering the vehicle autonomously into the service station in response to the low-speed maneuvering system being activated, wherein the maneuvering includes maneuvering the vehicle relative to a location of the at least one rail as determined by the CV machine-learning model.

According to one embodiment, a system for autonomously maneuvering a vehicle into a service station includes a plurality of cameras mounted to the vehicle and configured to capture images of an environment outside the vehicle, a processor communicatively coupled to the plurality of cameras, and memory. The memory has instructions that, when executed, cause the processor to: execute a computer vision (CV) machine-learning model to process the images and determine a presence of at least one rail located in the environment; determine that the vehicle is located near a service station based upon at least the determined presence of the at least one rail; generate, on a vehicle user interface, an interactive display providing an operator of the vehicle with an option to command the vehicle to activate a low-speed maneuvering system, wherein the interactive display is generated in response to the determination that the vehicle is located near the service station, and output control signals to autonomously maneuver the vehicle into the service station in response to the low-speed maneuvering system being activated, wherein the control signals cause the vehicle to maneuver relative to a location of the at least one rail as determined by the CV machine learning model.

According to one embodiment, a computer-readable storage medium contains instructions that, when executed by one or more processors, cause the one or more processors to: receive images from one or more cameras mounted to the vehicle; process the images via a computer vision (CV) machine-learning model, wherein the CV machine-learning model is configured to determine a presence of at least one rail located in front of the vehicle; determine that the vehicle is located near a service station based upon at least the determined presence of the at least one rail;
generate, on a vehicle user interface, an interactive display providing an operator of the vehicle with an option to command the vehicle to activate a low-speed maneuvering system, wherein the interactive display is generated in response to the determination that the vehicle is located near the service station; and issue autonomous driving commands to maneuver the vehicle into the service station in response to the low-speed maneuvering system being activated, wherein the commands are issued based on a location of the at least one rail as determined by the CV machine-learning model.

### BRIEF DESCRIPTION OF THE DRAWINGS

FIG. 1 is a schematic top view of a vehicle equipped with a low-speed maneuvering system, according to an embodiment.

FIG. 2 is a schematic diagram of a computing system for controlling various aspects of the vehicle, according to an embodiment.

FIG. 3 is a view of a scene of a service station as detected from a vehicle sensor, according to an embodiment.

FIGS. 4A-4E are examples of various prompts and commands issued to a user via a vehicle display for activation of the low-speed maneuvering system.

FIG. 5 is a flow chart of a method for autonomously maneuvering a vehicle into a service station, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Autonomous vehicles have revolutionized the way people envision transportation, offering potential benefits like improved safety, reduced traffic congestion, and increased efficiency. However, there are challenges when it comes to their interaction with service stations and car washes. Autonomous vehicles rely heavily on precise mapping and sensor technology for navigation, which can be problematic in these scenarios. For one, service stations and car washes often require very precise wheel placement so that a vehicle repair person can access the underside of the vehicle, or so that the vehicle is properly aligned with the tracks that move the vehicle through a car wash. Additionally, service stations and car washes often lack the standardized and updated mapping data required for autonomous vehicles to navigate accurately.

Moreover, the procedures involved in refueling, washing, or servicing a vehicle can be complex and typically require human intervention. Autonomous vehicles may struggle to communicate effectively with service station attendants or adapt to the ever-changing procedures and equipment at different locations. For example, at vehicle service stations or car washes, typically an employee uses his or her hands to direct the driver of the vehicle either left or right so that the vehicle is in proper alignment. These gestures might be useless with an autonomous vehicle where no human driver is controlling the vehicle. It is therefore desirable to advance autonomous vehicle technology such that the autonomous vehicle can autonomously navigate into service stations and car washes, where precise wheel alignment is crucial.

Therefore, according to various embodiments disclosed herein, an autonomous vehicle control system autonomously maneuvers a vehicle in and/or out of a vehicle service station and car wash. In embodiments, the control system is computer-vision based, and is configured to process images via a computer vision machine-learning model, wherein the model determines a presence of one or more rails located in front of the vehicle. The system can also determine that the vehicle is near a service station or car wash. Based on the presence of a rail and the determined location being near a service station or car wash, the control system can activate a low-speed maneuvering system which maneuvers the vehicle into proper alignment based on the location of the rail(s) using the computer vision system, e.g. without human intervention. Optionally, an interactive display can be generated to enable a human to confirm a desire for the vehicle to enter the service station or car wash. Upon approval or confirmation from the user, the control system can autonomously maneuver the vehicle appropriately.

One or more rails located at the service station or car wash are typically present for proper alignment of the vehicle wheels. For example, the rails can align the wheels so that an access hole in the ground will allow a technician to access the underside of the vehicle to perform maintenance (e.g., change engine oil, charge a vehicle battery, etc.). The rails also can align the wheels so that an underlying track can move the vehicle through a car wash. The systems disclosed herein can understand the presence of such a rail using image processing. The system can also access the vehicle's location (e.g., via GPS or other locational systems), which can also indicate that the vehicle is at or near a service station or car wash. This determined location confirms that the rail identified in the image processing is a rail for alignment of a vehicle wheel at the service station or car wash.

The systems disclosed herein assist a driver to track and autonomously maneuver the vehicle on floor rails for mechanic visits, oil changes, car washes, and the like. Without such a system, the vehicle may not be able to accurately locate itself for proper alignment, where very particular alignment is necessary. Moreover, the systems disclosed herein provide human interaction with a seamless display that allows the vehicle owner to confirm the desire for the vehicle to enter the service station or car wash.

As used herein, the term “service station” is meant to cover any location where a vehicle is serviced by a technician. This can include a structure that houses people for performing repairs, oil changes, tune-ups, and the like. In the interest of brevity, the term “service station” can also include car washes, including locations whereupon wheels of the vehicle are maneuvered onto a platform or track that moves the vehicle forward as it is being washed.

As used herein, the term “autonomous vehicle” is intended to cover fully-autonomous vehicle capable of performing all driving tasks without human intervention (e.g., Level 4 or Level 5 automation as set by SAE standards), or semi-autonomous vehicle that automate some driving tasks but require human supervision and active engagement of a human driver (e.g., Level 2 or Level 3 automation according to SAE).

As used herein, the term “rail” is intended to cover physical rails protruding from a wall or floor, such as rails of a car wash that direct and locate wheel(s) of a vehicle. The term “rail” can also include a physical boundary where a wheel of a vehicle should not cross, such as a hole in the ground where a technician can access the underside of the vehicle (e.g., to perform an oil change). The term “rail” can also include a colored strip or boundary line representing a line that should align with the vehicle's wheels as the wheels are traveled into a service station. The term “rail” can also include a strip of material on a tow truck, indicating where the vehicle should be positioned on the tow truck.

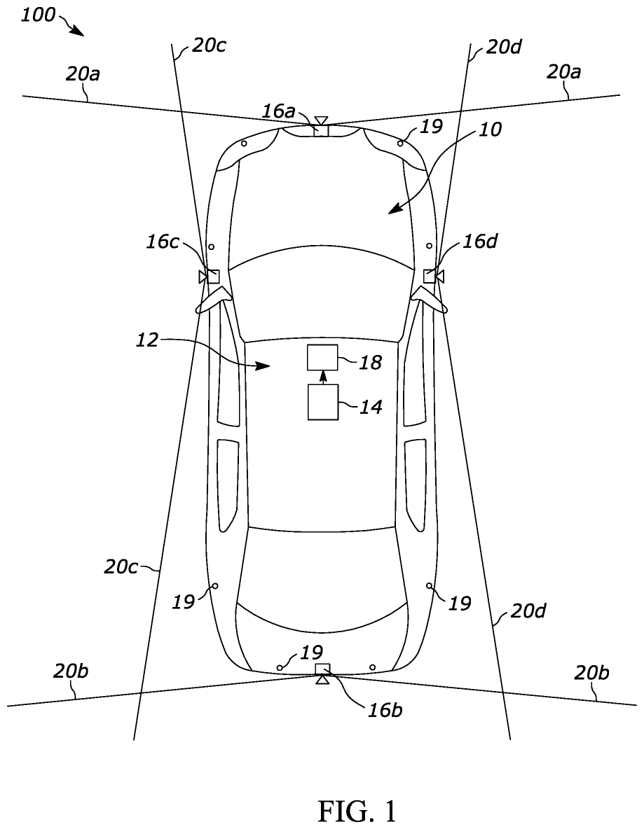

FIG. 1 illustrates a schematic of a vehicle 10 according to an embodiment, shown here from a top view. The vehicle 10 is a passenger car, but can be other types of vehicles such as a truck, van, or sports utility vehicle (SUV), or the like. The vehicle 10 may be an autonomous vehicle. The vehicle 10 includes a camera system 12 which includes an electronic control unit (ECU) 14 connected to a plurality of cameras 16a, 16b, 16c, and 16d. In general, the ECU 14 includes one or more processors programmed to process the images data associated with the cameras 16a-d and generate a composite top view on a vehicle display 18. In addition, as will be described further below, the vehicle 10 includes a plurality of proximity sensors (e.g., ultrasonic sensors, radar, sonar, LiDAR, etc.) 19. The proximity sensors 19 can be connected to their own designated ECU that develops a sensor map of objects external to the vehicle. Alternatively, the proximity sensors can be connected to ECU 14. The proximity sensors 19 and cameras 16a-d can collectively and generally be referred to as vehicle sensors.

The ECUs disclosed herein may more generally be referred to as a controller. In the case of an ECU of a camera system 12, the ECU can be capable of receiving image data from the various cameras (or their respective processors), processing the information, generating information on a vehicle display, and outputting operating instructions to maneuver the vehicle 10, for example. In the case of an ECU associated with the proximity sensors 19, the ECU can be capable of receiving sensor data from the various proximity sensors (or their respective processors), processing the information, and outputting a sensor map of objects surrounding the vehicle; this ECU can also be capable of outputting operating instructions to maneuver the vehicle. In this disclosure, the terms “controller” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured to, upon execution by the processor, cause the harmonization techniques and algorithms described herein.

In the embodiment illustrated in FIG. 1, the cameras 16a-d are located about different quadrants of the vehicle, although more than four cameras may be provided in the camera system 12. Each camera 16a-d may have a fish-eye lens to obtain images with an enlarged field of view, indicated by boundary lines 20a-d. In an example, a first camera 16a faces an area in front of the vehicle, and captures images with a field of view indicated by boundary lines 20a. The first camera 16a can therefore be referred to as the front camera. A second camera 16b faces an area behind the vehicle, and captures images with a field of view indicated by boundary lines 20b. The second camera 16b can therefore be referred to as the rear camera. A third camera 16c faces an area on the left side of the vehicle, and captures images with a field of view indicated by boundary lines 20c. The third camera 16c can therefore be referred to as the left camera, or left-side camera. The third camera 16c can also be mounted on or near the vehicle's left wing mirror, and can therefore be referred to as a mirror left (ML) camera. A fourth camera 16d faces an area on the right side of the vehicle, and captures images with a field of view indicated by boundary lines 20d. The fourth camera 16d can therefore be referred to as the right camera, or right-side camera. The fourth camera 16d can also be mounted on or near the vehicle's right wing mirror, and can therefore be referred to as a mirror right (MR) camera. The images (or the associated image data) originating from the cameras 16a-d can be processed by the ECU 14 as part of a computer vision system to issue maneuvering controls, as disclosed herein.

Use of the cameras 16a-d and associated controller(s) as part of a computer vision (CV) system can maneuver the vehicle. For example, as will be described below, the image data produced by cameras 16a-d can indicate the presence of a rail at the entrance or within a service station. The associated controllers can determine the presence of the rail. The processors can issue maneuvering commands as part of a low-speed maneuvering system 100. The low-speed maneuvering system 100 may include a vehicle propulsion device, such as an engine, electric motor, or other suitable device. The low-speed maneuvering system 100 may also include a vehicle steering wheel, associated motor for turning the steering wheel, and all other mechanisms that transfer steering-wheel movement into turning of the vehicle's drive wheels.

The term “low-speed maneuvering system” can cover an operational system of the vehicle in which the vehicle is operated to maneuver to avoid objects or properly align itself while traveling at low speeds (e.g., below 20 miles per hour, as an example). In semi-autonomous vehicles, the low-speed maneuvering system 100 can cover a range of advanced driver assistance features that assist the driver during slow-speed or low-speed situations, typically below a certain speed threshold. These features are designed to improve safety and convenience in situations where precise control and awareness are crucial. This can include automatic parking, for example. Other functionalities that can be controlled by a low-speed maneuvering system include: adaptive cruise control (ACC) that maintains a set distance between the vehicle 10 and another vehicle ahead; traffic jam assist that can automatically control acceleration, braking, and steering in stop-and-go traffic; lane centering or lane-keeping assist that keeps the vehicle within its lane by providing steering inputs when the car starts to drift out of the lane; pedestrian detection and avoidance; collision avoidance; parking assistance; and others.

The low-speed maneuvering system 100 can also be referred to as a slow-speed maneuvering system, low-velocity navigation system, precise maneuvering aid, or the like. The system 100 can include the cameras 16a-d, associated processors configured to process image data, and a controller configured to output low-speed maneuvering commands to autonomously maneuver the vehicle into a proper alignment or position based on the processed image data.

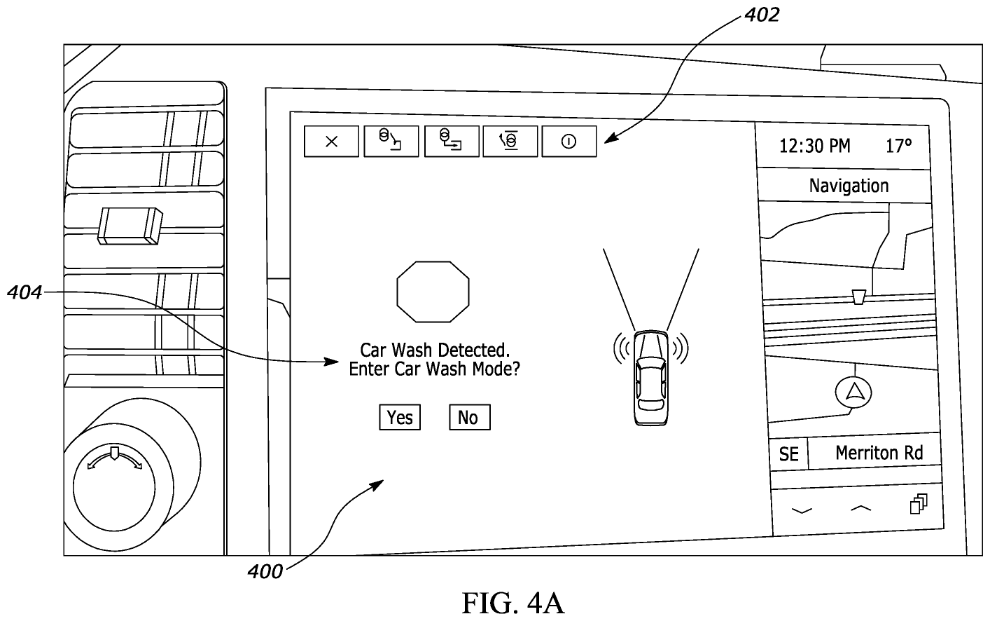

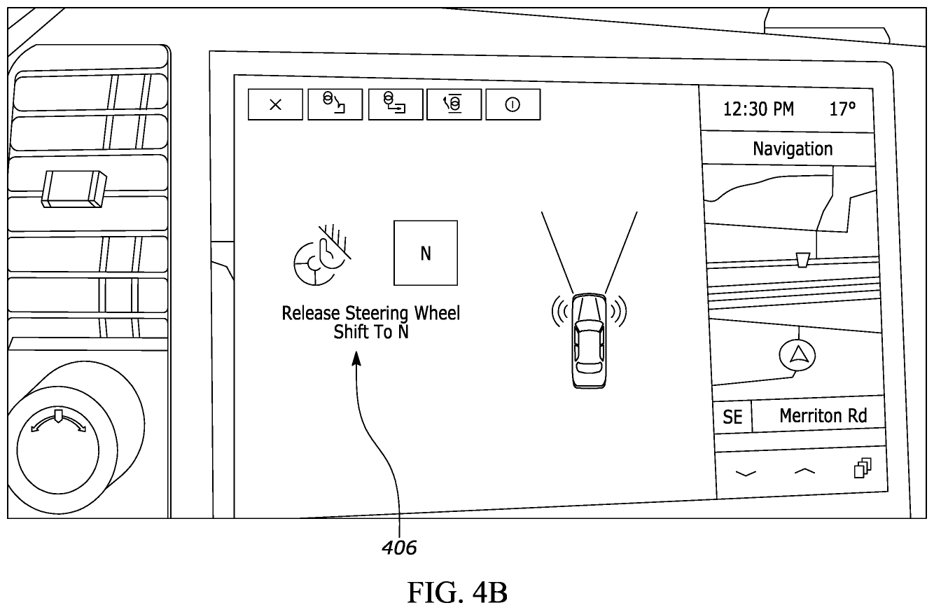

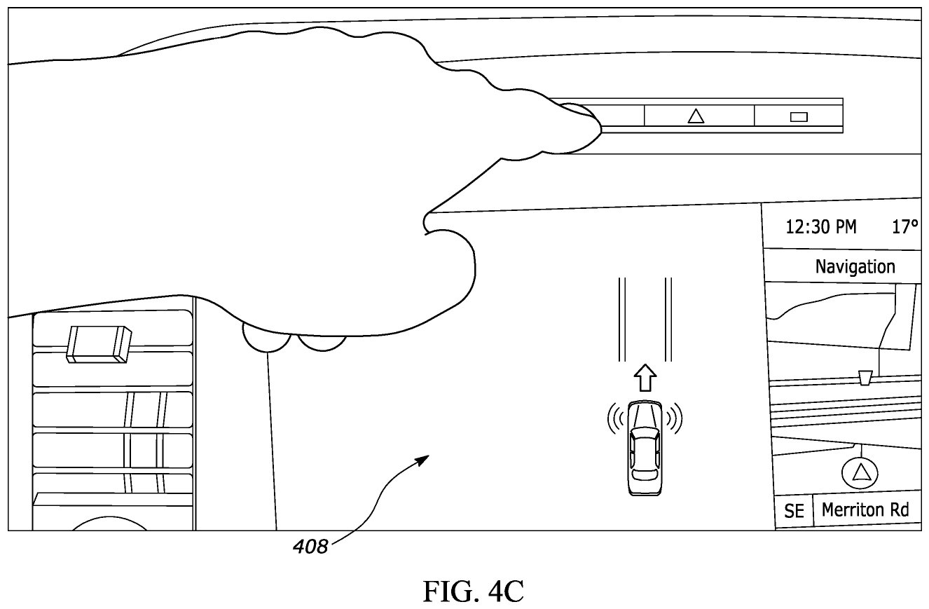

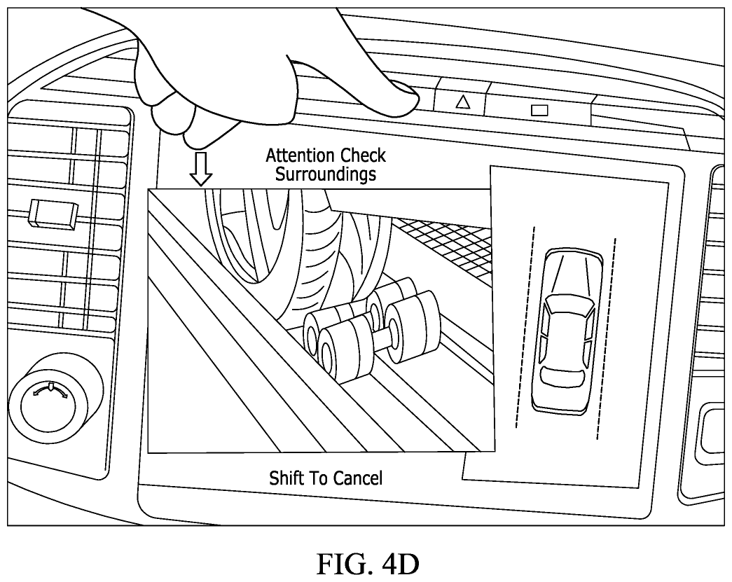

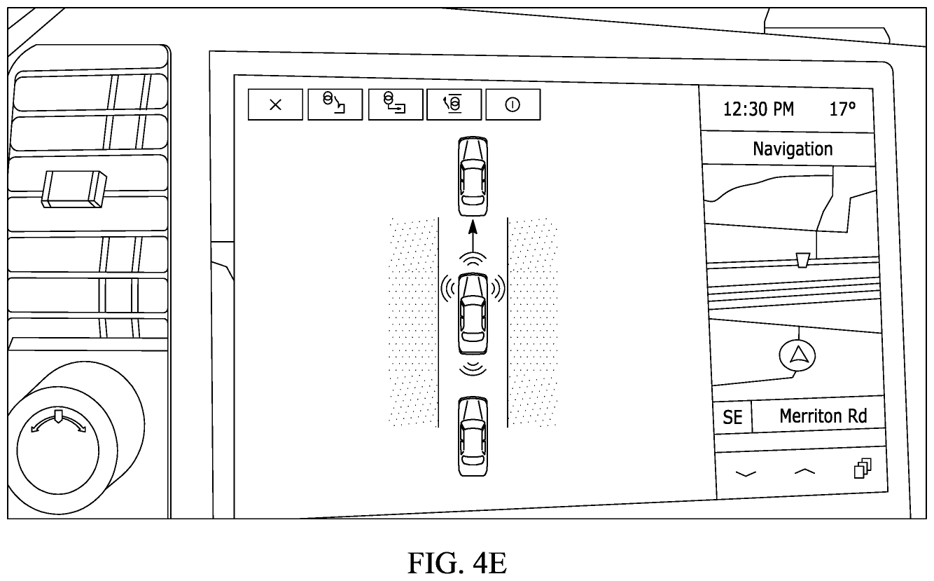

In the case of a semi-autonomous vehicle, as will be described with reference to FIGS. 4A-4E, the low-speed maneuvering system 100 can be activated based on user input. For example, the driver may be manually operating and steering the system, but can activate the low-speed maneuvering system 100 to take control of the vehicle 10 and maneuver the vehicle relative to the detected guide(s). Thus, the driver places the vehicle in a mode in which the vehicle maneuvers itself autonomously, requiring no acceleration or steering input from the human driver. Instead, the low-speed maneuvering system 100 commands the vehicle propulsion device to generate sufficient power to propel the vehicle, and commands the steering wheel to turn the driving wheels to a certain angle such that the vehicle 10 is automatically aligned with the rail.

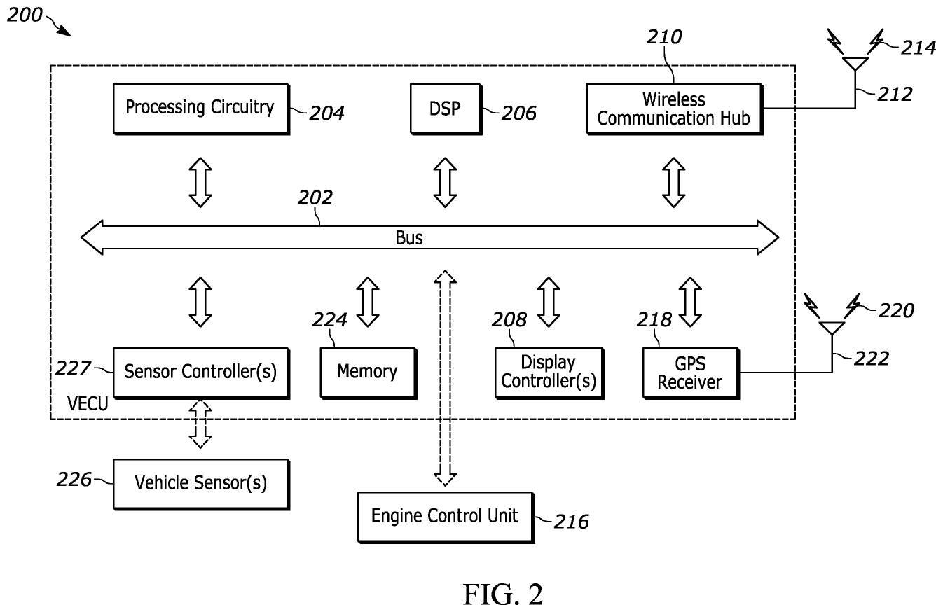

FIG. 2 is a block diagram of internal components of an exemplary embodiment of the low-speed maneuvering system, illustrated more generally as a computing system 200. The computing system 200 may include or be used to implement the systems described above. In this embodiment, the computing system 200 may be embodied at least in part in a vehicle electronics control unit (VECU). It should be noted that FIG. 2 is meant only to provide a generalized illustration of various components, any or all of which may be utilized as appropriate. It can be noted that, in some instances, components illustrated by FIG. 2 can be localized to a single physical device and/or distributed among various networked devices, which may be disposed at different physical locations.

The computing system 200 has hardware elements that can be electrically coupled via a BUS 202. The hardware elements may include processing circuitry 204 which can include, without limitation, one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform the operations disclosed herein, including, among others, image processing, data processing, and implementation of the machine learning models described above. Some embodiments may have a separate DSP 206, depending on desired functionality. The computing system 200 can also include one or more display controllers 208, which can control the vehicle display devices disclosed herein, such as an in-vehicle touch screen, screen of a mobile device, and/or the like. This display controller 208 can be or include its own processor, such as a graphics processing unit (GPU) or the like.

The computing system 200 may also include a wireless communication hub 210, or connectivity hub, which can include a modem, a network card, an infrared communication device, a wireless communication device, and/or a chipset (such as a Bluetooth device, an IEEE 802.11 device, an IEEE 802.16.4 device, a WiFi device, an LTE device, cellular communication facilities including 4G, 5G, etc.), and/or the like. The wireless communication hub 210 can permit data to be exchanged with a wireless communication network, wireless access points, other computing systems, etc. The communication can be carried out via one or more wireless communication antenna 212 that sends and/or receives wireless signals 214.

The computing system 200 can also include or be configured to communicate with an engine control unit 216 configured to control the power output of the vehicle's engine. In the case of a vehicle that does not include an internal combustion engine, the engine control unit may instead be a battery control unit or electric drive control unit configured to command propulsion of the vehicle via the vehicle's electric motor. The engine control unit 216 can be operated in order to control the movement of the vehicle during, for example, a low-speed maneuver such as aligning the vehicle with one or more rails of a service station.

The computing system 200 also includes vehicle sensors 226 such as those described above with reference to FIG. 1. These sensors can include, without limitation, one or more accelerometer(s), gyroscope(s), camera(s) (e.g., cameras 16a-d), radar(s), LiDAR(s), odometric sensor(s), and ultrasonic sensor(s), as well as magnetometer(s), altimeter(s), microphone(s), proximity sensor(s), light sensor(s), and the like. These sensors can be controlled via associated sensor controller(s) 227.

The computing system 200 may also include a GPS receiver 218 capable of receiving signals 220 from one or more GPS satellites using a GPS antenna 222. The GPS receiver 218 can extract the position of the device, using conventional techniques, from satellites of a GPS system, such as a global navigation satellite system (GNSS) (e.g., Global Positioning System (GPS)), Galileo, GLONASS, Compass, Galileo, Beidou and/or other regional systems and/or the like. The GPS receiver 218 can be utilized in determining the relative position of the vehicle compared to structures, such as service stations.

The computing system 200 can also include or be in communication with a memory 224. The memory 224 can include, without limitation, local and/or network accessible storage, a disk drive, a drive array, an optical storage device, a solid-state storage device, such as a RAM which can be programmable, flash-updateable and/or the like. Such storage devices may be configured to implement any appropriate data stores, including without limitation, various file systems, database structures, and/or the like. The memory 224 can also include software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

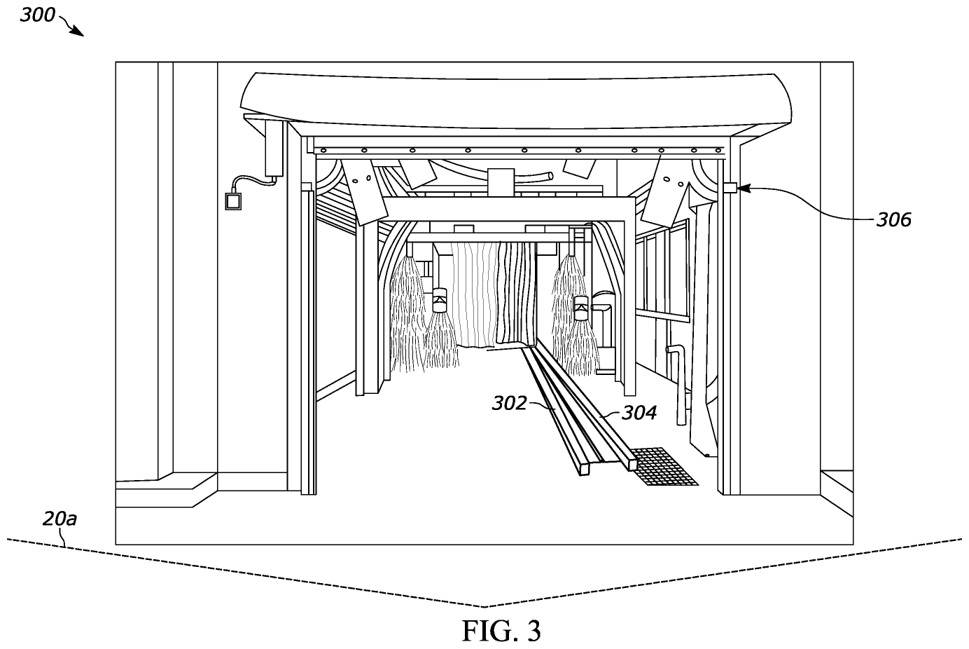

FIG. 3 illustrates an example of one scene 300 of an environment outside of the vehicle 10. The scene 300 can be detected by image sensors such as those disclosed in FIG. 1 (e.g., cameras 16a-d). Here, this scene 300 is the surrounding environment in front of the vehicle within the field of view of the front camera 16a, indicated by boundary lines 20a. In this particular embodiment, scene 300 includes a car wash. Of course in other embodiments, the scene can be any of the service stations described above.

The car wash includes a first rail 302 and a second rail 304. The rails 302, 304 direct and locate the vehicle's wheels onto a track that moves those wheels through the car wash. In other words, when a driver of a vehicle travels into the car wash, the wheels are directed by the driver to fit between the two rails 302, 304. This can be performed autonomously by the systems described herein, such as the computing system 200, computer vision (CV) system, low-speed maneuvering system, and the like. For example, the computing system 200 can process the image data produced by the camera(s) 16a-d and/or other vehicle sensors 226. The computing system can utilize computer vision or object recognition techniques to determine the presence and location of rails 302, 304.

To perform the CV functions and image processing disclosed herein, the computing system can rely on CV machine-learning models. In this context, cameras 16a-d and/or other vehicle sensors 226 capture real-time images and data from the vehicle's surroundings 300. Machine learning algorithms then process this data to identify and classify objects. Object detection algorithms like YOLO (You Only Look Once) or Faster R-CNN are employed to locate objects (such as rails 302, 304) within the images. These algorithms use convolutional neural networks (CNNs) to analyze various features, such as edges, shapes, and colors, to pinpoint objects of interest. Once the objects are detected, machine learning models for classification enable the computing system to recognize the type of object, like rail 302, 304, pedestrians, other vehicles, or road signs.

In embodiments, the machine-learning models disclosed herein (e.g., YOLO, Faster R-CNN, etc.) involve a combination of processors and memory (e.g., shown in FIG. 2) to efficiently process the image data to make accurate predictions. First, the input images captured by the cameras 16a-d and/or other vehicle sensors 226 are loaded into memory for processing. Before feeding the image data to the object detection model, preprocessing steps can be applied, such as resizing the image to a fixed size and normalizing the pixel values. These operations are performed by the CPU or GPU and are relatively lightweight in terms of memory usage. Both YOLO and Faster R-CNN utilize convolutional neural networks (CNNs) for feature extraction. These networks consist of multiple layers of convolutional and pooling operations. The layers in these networks have weights and biases that are learned during training. The CNN layers extract features like edges, textures, and shapes from the image. The memory used by these layers depends on the network architecture and the size of intermediate feature maps. After feature extraction, the processed image data is passed through the object detection head, which is responsible for predicting bounding boxes and class probabilities. In the case of YOLO, a single convolutional network predicts bounding boxes and class probabilities directly. In the case of Faster R-CNN, a region proposal network (RPN) suggests potential regions of interest, which are then refined and classified. Once the object detection head makes predictions, post-processing is performed to filter and refine the results. This may include non-maximum suppression to eliminate duplicate detections and thresholding to retain only high-confidence predictions. The final detected objects, along with their bounding boxes and class labels, can be stored in memory or used for further processing, such as displaying the results on a screen or making decisions in an autonomous vehicle's control system (e.g., navigating the vehicle such that the wheels align with the detected rails for proper vehicle alignment within a service station).

In other embodiments, rather than YOLO or Faster R-CNN, other machine-learning models can be implemented. For example, Single Shot MultiBox Detector (SSD) can be used wherein a single deep neural network is used to predict bounding boxes and class scores at multiple scales within the image to detect objects of varying sizes effectively. In another embodiment, RetinaNet, EfficientDet, or other object-recognition machine-learning models are used for object detection. Any of the above-described machine learning models can generally be referred to as a CV machine-learning model. The machine-learning models can utilize a combination of memory 224 and processing circuitry 204 of the computing system 200 to perform the functions, such as object recognition, labeling, and the like.

The computing system 200 can rely on the detected objects to understand that the vehicle is in a service station. For example, the presence and location of rails 302, 304 can allow the computing system to realize the vehicle is in a service station. The computing system 200 can also use other context information in the scene other than the presence of rails 302 to recognize that the vehicle is at a service center. For example, the computing system 200 can process the image data to determine the location and presence of a garage opening 306, defined as an opening in a wall generally sized to fit a vehicle therein. Based on the presence of a garage opening 306 and at least one rail 302, 304, the computing system can recognize that the vehicle is at a service station, namely a car wash in the illustrated embodiment.

Other examples of context information in the scene that enable the computer vision to recognize that the vehicle is at a service center are contemplated. For example, the computing system can determine the presence of work stations, humans standing or moving slowly within a contained area (e.g., garage), garage doors, light bays, openings in the ground for technicians to access the underside of the vehicle, and the like.

In other embodiments, the computing system can rely on map data or vehicle locational data to recognize that the vehicle is at a service station. For example, the GPS location of the vehicle (as determined by GPS receiver 218, for example) can match a location of a service station. The location of the vehicle may be within a parking lot, alley, or other location adjacent to the service station or within a certain defined distance from the service station in order for the computing system 200 to recognize the vehicle is at a service station. Relying on map data can confirm the computing system's determination that the vehicle is located at or near a service station. For example, the computing system 200 might be programmed to determine the vehicle is at a service station based on the image data processing only if confirmed by map data indicating that the vehicle is located within a threshold distance (e.g., 100 feet) of the location of a service station on the map data. In other words, in some embodiment, the computing system 200 will not output a confident decision that the vehicle is located at a service station unless confirmed via map data, regardless of the determinations made by the CV machine-learning model.

FIG. 4A illustrates an example of a user interface 400 on a vehicle display 402. The vehicle display can be an electronic screen (e.g., LED, LCD, etc.) that visually displays information to the driver and/or passengers, typically located beneath the dashboard in the center of the instrument panel. However, such a location is not required. The vehicle display 402 can be located in front of the passenger seat for example. The vehicle display 402 can be located in any location within the vehicle that can give the driver the ability to receive or read information presented to him/her, and react by providing the vehicle display 402 with an input or selection. For example, the vehicle display 402 may be a touch screen. The vehicle display 402 may also include displays that are not physically mounted to the vehicle, such as personal devices (e.g., smart phones, tablets, etc.) that are communicatively connected to the vehicle's computing system.

The user interface 400 may be displayed to the driver as controlled by the computing system 200. For example, display control 208 can control what information is displayed on the user interface 400 of the vehicle display 402. The display control 208 can control the user interface 400 to display various data of the vehicle, such as the vehicle speed, location, and the like.

In embodiments, the display control 208 commands the user interface 400 to inform the driver that the vehicle has approached a service station. This display can be generated based on the computing system 200 determining the presence of rails along with map information, or other embodiments as described above. Based on the Computing system 200 detecting that the vehicle has entered a service station, the user interface 402 can produce a prompt 404 that can read, for example, “car wash detected”, other props can be used that indicate to the driver that a car wash or other service station is detected nearby via the computing system 200. The prompt 404 can also give the ability for the driver to either confirm or deny the vehicle to enter a “service station mode,” or “car was mode” as shown in this illustrated embodiment in which the service station is a detected car wash. If a driver selects ‘no’ on the user interface 402, the vehicle will continue its normal operation. Alternatively, if the driver selects ‘yes’ on the user interface 402 the vehicle can enter the car wash mode. In the “car wash mode” or “service station mode,” the computing system 200 can operate the vehicle autonomously such that the wheels are aligned with the detected rail as described previously.

Providing the prompt 404 may be optional. For example, in other embodiments, the prompt 404 is not provided and instead the vehicle can automatically enter the car wash mode or service station mode with different confirmation methods provided by the driver.

FIG. 4B illustrates a subsequent prompt 406 provided to the driver. This prompt 406 can provide instructions for how to place the vehicle in the car wash mode or service station mode. For example, in one embodiment, the prompt 406 can instruct the driver to shift the vehicle into Neutral gear. In other embodiments, the driver is instructed to press a button (either physical button on an instrument panel or virtual button on the user interface) that places the vehicle in the car wash mode or service station mode. The driver may also be instructed to release the steering wheel so as to not interfere with the automatic maneuvering of the vehicle during the car wash mode or service station mode.

FIG. 4C illustrates a subsequent prompt 408 according to an embodiment. Here, the user interface can prompt the user to release the brake pedal and press and hold a button on the user interface. This is yet another layer of confirmation and instruction provided by the user to place the vehicle in the car wash mode or service station mode.

The prompts shown in FIGS. 4A-4C are embodiments of confirming to the computing system 200 that the driver desires to place the vehicle in an autonomous mode of operation (e.g., the low-speed maneuvering system is activated). For safety purposes, it may be necessary to complete at least one, but perhaps two or all three layers of prompts and instructions before the vehicle activates the low-speed maneuvering system by entering the car wash mode or service station mode. Following multiple prompts and instructions can prohibit an accidental activation of the low-speed maneuvering system. During the low-speed maneuvering, the vehicle display can show a view from one of the vehicle cameras (e.g., camera 16a-d) where the rail is detected. An example of this is shown in FIG. 4D. This allows the driver of the vehicle to visually see the precise maneuvering that the vehicle is automatically undertaking, giving the driver visual confirmation that the maneuvering is underway and properly executed. For example, as shown in the example of FIG. 4D, one of the vehicle wheels is between rails 302 and 304, and this live feed is displayed on the vehicle display 402. Additionally, in some embodiments, an overhead view or bird-eye-view (BEV) can be shown on the vehicle display when the low-speed maneuvering system is active. An example of this is shown in FIG. 4E, in which a virtual image of the vehicle is shown along with an overhead view of the area surrounding the vehicle, including any other vehicles within the field of view of the cameras 16a-d. The overhead view can be shown during any of the prompts described herein. The overhead view can be created by one or more processors described herein by, for example, projecting and stitching together views from the various cameras 16a-d as known in the art.

While not illustrated, in another embodiment the computing system 200 activates a speaker to provide the driver with an audible warning or confirmation that the vehicle is to enter the car wash mode or service station mode. For example, rather than a visual prompt on a vehicle display, the speakers of the vehicle can produce a sound asking the driver if he/she wishes to enter a service station mode. (For example, the speaker may ask “Car wash detected. Would you like to enter Car Wash Mode?”) A microphone on-board the vehicle can then be activated to listen to the driver's response. For example, if the driver says “yes,” the computing system 200 will respond accordingly.

Once placed in the car wash mode or service station mode, the low-speed maneuvering system is activated. As described above, the low-speed maneuvering system is an operational system of the vehicle in which the vehicle is autonomously operated to maneuver to avoid objects or properly align itself while traveling at low speeds. In an embodiment, the computing system 200 will use the processed image data to issue control signals (e.g., via engine control unit 216) to accelerate the vehicle forward, and will issue steering commands to rotate the steering wheel or drive wheels such that the vehicle's drive wheels are aligned with the rail(s) of the service station. In other words, the vehicle will autonomously maneuver into the service station to a correct location, based on the location of the guide(s) as determined by the CV machine-learning model. As these maneuvers may be difficult for some inexperienced human drivers, the autonomous control of the vehicle can help the driver by removing the necessity for the driver to perform these maneuvers himself or herself.

In one embodiment, when the low-speed maneuvering system is active, the computing system 200 is configured to issue autonomous control commands to place the driving wheels directly adjacent to a rail, or between two rails. In another embodiment, the computing system 200 is configured to issue the autonomous control commands to place the driving wheels a certain distance away from the guide. For example, in an embodiment in which the service station is one with a hole in the ground to allow service technicians to access the underside of the vehicle (e.g., during an oil change), the vehicle can be autonomously controlled such that the wheels remain a specific distance away from the hole. The vehicle can be maneuvered such that the hole is centered beneath the vehicle.

During the autonomous maneuvering while the low-speed maneuvering system is activated, image data from the cameras and/or other data from the other vehicle sensors can be processed by the CV machine-learning model to properly position and align the vehicle.

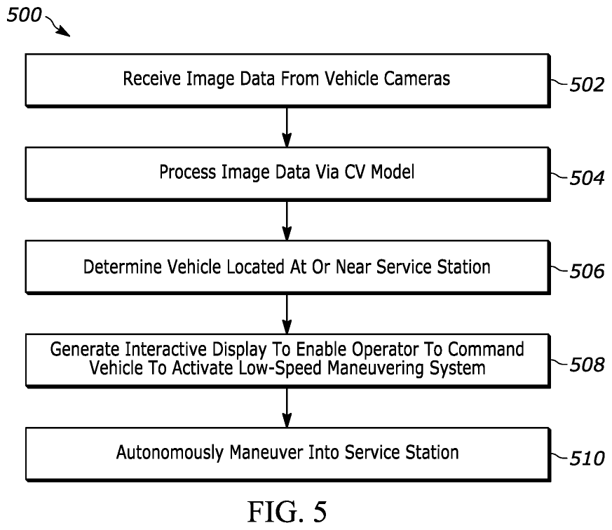

FIG. 5 illustrates a flow chart 500 of a method for autonomously maneuvering a vehicle into a service station. The method may be executed by one or more processors, such as those illustrated in FIG. 2 as part of the computing system 200.

At 502, the computing system receives images (or image data) from the vehicle cameras, such as cameras 16a-d illustrated in FIG. 1. The data received can also include data from other vehicle sensors as described above. At 504, the computing system processes the images using a computer vision (CV) machine-learning model, such as those described above. The CV machine-learning model is configured to utilize object detection or the like to determine a presence of a rail located in front of the vehicle. This determination may be made based on the length, depth, height, location relative to the ground, and other visual characteristics about the rail.

At 506, based at least in part on the CV machine-learning model's output of a determination that a rail is present, the computing system determines that the vehicle is located at or near a service station, such as a car wash. This determination can also be made based on other data as explained above, such as map data indicating a nearby car wash or other service station.

At 508, once it is determined that the vehicle is located at or near a service station, the computing system generates, on a vehicle user interface of a display device, an interactive display. The interactive display provides an operator of the vehicle with an option to command the vehicle to activate a low-speed maneuvering system to autonomously move the vehicle into or through the service station. The interactive display can be generated in response to the determination that the vehicle is located at or near the service station. The human can interact with the display to activate the low-speed maneuvering system, for example by pressing a button, saying “yes” verbally, or other confirmations as described above.

At 510, once the vehicle has activated the low-speed maneuvering system, the vehicle autonomously maneuvers into the service station. This includes maneuvering the vehicle relative to the determined location of the rail via the CV machine-learning model. For example, the computing device can control the vehicle's propulsion system and steering system to slowly and automatically maneuver the vehicle into the service station by placing the driving wheels in-line with the rail(s).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for autonomously maneuvering a vehicle into a service station, the method performed by a computing system and the method comprising:
receiving images from one or more cameras mounted to the vehicle;
processing the images via a computer vision (CV) machine-learning model, wherein the CV machine-learning model is configured to determine a presence of at least one rail located in front of the vehicle;
determining that the vehicle is located near the service station based upon at least the determined presence of the at least one rail;
generating, on a vehicle user interface, an interactive display providing an operator of the vehicle with an option to command the vehicle to activate a low-speed maneuvering system, wherein the interactive display is generated in response to the determination that the vehicle is located near the service station; and
maneuvering the vehicle autonomously into the service station in response to the low-speed maneuvering system being activated, wherein the maneuvering includes maneuvering the vehicle relative to a location of the at least one rail as determined by the CV machine-learning model.

2. The method of claim 1, further comprising:
receiving map data via a Global Positioning System (GPS);
wherein the determining that the vehicle is located near a service station is further made based upon the map data.

3. The method of claim 2, wherein the map data includes a label of a nearby location as being a type of service station.

4. The method of claim 1, wherein the service station is a car wash.

5. The method of claim 1, wherein the maneuvering includes issuing acceleration commands and steering commands to autonomously maneuver one or more wheels of the vehicle to align with the at least one rail.

6. The method of claim 1, further comprising:
confirming, via a prompt on the user interface, that the operator desires to activate the low-speed maneuvering system;
wherein the maneuvering is performed only after receiving confirmation from the operator.

7. The method of claim 6, wherein the prompt includes instructions for the operator to release a brake pedal of the vehicle and release a steering wheel of the vehicle.

8. A system for autonomously maneuvering a vehicle into a service station, the system comprising:
a plurality of cameras mounted to the vehicle and configured to capture images of an environment outside the vehicle;
a processor communicatively coupled to the plurality of cameras; and
memory having instructions that, when executed by the processor, cause the processor to:
execute a computer vision (CV) machine-learning model to process the images and determine a presence of at least one rail located in the environment;
determine that the vehicle is located near the service station based upon at least the determined presence of the at least one rail;
generate, on a vehicle user interface, an interactive display providing an operator of the vehicle with an option to command the vehicle to activate a low-speed maneuvering system, wherein the interactive display is generated in response to the determination that the vehicle is located near the service station, and
output control signals to autonomously maneuver the vehicle into the service station in response to the low-speed maneuvering system being activated, wherein the control signals cause the vehicle to maneuver relative to a location of the at least one rail as determined by the CV machine learning model.

9. The system of claim 8, wherein the memory has further instructions that, when executed by the processor, cause the processor to:
receive map data via a Global Positioning System (GPS);
determine that the vehicle is located near the service station based upon the map data.

10. The system of claim 9, wherein the map data includes a label of a nearby location as being a type of service station.

11. The system of claim 8, wherein the service station is a car wash.

12. The system of claim 8, wherein the control signals include acceleration commands and steering commands to autonomously maneuver one or more wheels of the vehicle to align with the at least one rail.

13. The system of claim 8, wherein the memory has further instructions that, when executed by the processor, cause the processor to:
confirm, via a prompt on the user interface, that the operator desires to activate the low-speed maneuvering system;
wherein the control signals are output only after receiving confirmation from the operator.

14. The system of claim 13, wherein the prompt includes instructions for the operator to release a brake pedal of the vehicle and release a steering wheel of the vehicle.

15. A computer-readable storage medium containing instructions that, when executed by one or more processors, cause the one or more processors to:
receive images from one or more cameras mounted to a vehicle;
process the images via a computer vision (CV) machine-learning model, wherein the CV machine-learning model is configured to determine a presence of at least one rail located in front of the vehicle;
determine that the vehicle is located near a service station based upon at least the determined presence of the at least one rail;
generate, on a vehicle user interface, an interactive display providing an operator of the vehicle with an option to command the vehicle to activate a low-speed maneuvering system, wherein the interactive display is generated in response to the determination that the vehicle is located near the service station; and
issue autonomous driving commands to maneuver the vehicle into the service station in response to the low-speed maneuvering system being activated, wherein the commands are issued based on a location of the at least one rail as determined by the CV machine-learning model.

16. The computer-readable storage medium of claim 15, wherein the instructions further cause the one or more processors to:
receive map data via a vehicle Global Positioning System (GPS); and
determine that the vehicle is located near the service station based upon the map data.

17. The computer-readable storage medium of claim 16, wherein the map data includes a label of a nearby location as being a type of service station.

18. The computer-readable storage medium of claim 15, wherein the autonomous driving commands include at least one of an acceleration command and a steering command to autonomously maneuver one or more wheels of the vehicle to align with the at least one rail based upon the CV machine-learning model.

19. The computer-readable storage medium of claim 15, wherein the instructions further cause the one or more processors to:
receive a confirmation, via a prompt on the user interface, that the operator desires to activate the low-speed maneuvering system;
wherein the autonomous driving commands are issued only after receiving the confirmation from the operator.

20. The computer-readable storage medium of claim 19, wherein the prompt includes instructions for the operator to release a brake pedal of the vehicle and release a steering wheel of the vehicle.
